(19) United States
(12) Patent Application Publication
(10) Pub. No.: US 2007/0263526 A1
(43) Pub. Date: Nov. 15, 2007

(54) File recording method and apparatus

(75) Inventor: Yukinori Yamamoto, Yokohama-shi (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/797,925

(22) Filed: May 9, 2007

(30) Foreign Application Priority Data
May 11, 2006 (JP) 2006-132447

(51) Int. Cl. G11B 7/24

(52) U.S. Cl. 369/275.4

(57) ABSTRACT

Of file management information for managing a file, information indicating at least a recording location of the file is recorded in a data area and a spare area, and the file is reproduced based on the information of the two areas. Even when a new defect is caused, because a File Entry, that is, a location and a size of image data is held in two locations, image reproduction is enabled even if the File Entry held in one location is lost. In addition, back up of the File Entry, which is held in one location due to the defect, can further be performed, whereby new defects caused afterward can be dealt with.

### BACKGROUND OF THE INVENTION

1. Field of the Invention

The present invention relates to a file recording method and apparatus for recording a file of a digitized image or voice onto an information recording medium such as an optical disk, and more particularly to a technology for protecting a recorded file.

2. Description of the Related Art

Recently, in place of a tape medium, a removable optical disk such as a CD-RW or a DVD-RW has come into wide use. This, together with the progress of a data compression technology such as MPEG, has facilitated recording of a digital image or voice. Additionally, a large-capacity optical disk such as a BD or a HD-DVD has been devised so that higher-quality and longer-time recording will be expected in the future.

The removable optical disk has the features that its mass producibility will realize cost reduction and data can be stored therein for a long period of time. Hereinafter, the description will focus on the latter feature, i.e., a method of securing reliability of recorded data.

Data recorded in such an optical disk includes a strong error correction code, and reproduction can be performed even when the data has random errors or burst errors due to some flaws or stains. However, in the case of a somewhat large hole-shaped error called a defect caused during disk manufacturing, or depending on the degree of a flaw or stain, an area which cannot be corrected by any means will be generated.

To deal with such a case, a function called defect management (or replacement process) has been defined in an optical disk standard.

Referring to FIGS. 8 and 9, an example of the replacement process will be described. As illustrated in FIG. 8, an optical disk is mainly composed of three areas, that is, a Lead-in located on an inner peripheral side, a Data Zone located at the center, and a Lead-out located on an outer peripheral side. Of the three areas, the Lead-in and the Lead-out are areas for physical management information or control information of the disk.

The Data Zone is further comprised of a Spare Area and a User Data Area. The Spare Area is an extra area utilized as a replacement area for a defective area present in the User Data Area. The User Data Area is an area from or to which a user is free to read or write data.

In the User Data Area, logical sector numbers (LSN) are sequentially allocated from an inner periphery, and a capacity which can be used by the user is defined based on the value of the last LSN. Physical sector numbers (PSN) are allocated sequentially from the Lead-in to the Lead-out to indicate physical locations on the disk. One LSN and one PSN correspond to each other, while no LSN is allocated to the Lead-in and the Lead-out.

A defect management area (DMA) is disposed in each of the Lead-in and the Lead-out. As illustrated in FIG. 8, the content of the DMA are a series of lists which include pairs of PSNs of a defective location and a replacement location. A PSN pair of one line is called a defect list (DFL). Status will be described later. Targets of defect management by the DMA are limited within the Data Zone. Accordingly, because own defects of the Lead-in and the Lead-out are not protected, a method is employed which secures reliability by repeatedly recording data in two (or more) places.

FIG. 9 illustrates a specific example of the replacement process. Defective locations are indicated by x marks in the figure, and User Data Areas A and B have uncorrectable defects, so that the User Areas A and B are replaced with Spare Areas. The User Area A is replaced with X. However, because Y also has a defect, the User Area B is alternated with subsequent Z. The DFL concerning Y in this case is indicated by the second line of the series of lists of FIG. 9, clearly demonstrating in “Status” that a defect is present at the location of Y and that location cannot be used as a replacement area.

When writing data in LSN=a or b in such a state in which the replacement process has been performed, actual data is recorded at each of the locations of X and Z with reference to the DMA. The replacement process will change the PSN corresponding to the LSN.

As described above, in the optical disk, even for an error-uncorrectable defect, a measure for securing the reliability of data has been taken. Incidentally, the technology regarding the above-mentioned file management method is described in, for example, Japanese Patent Application Laid-Open No. 2000-322835.

However, with the conventional technology, if a defective block is generated by a new dust or flaw after the recording has been entirely finished and the disk has been taken out, there is a possibility that reproduction cannot be preformed. Recently, a disk without a case called a bare disk has struck root, which is also responsible for the increase of the above-mentioned fear.

Further, in a portable device such as a camcorder, there are strict regulations on external conditions such as a temperature, humidity, and vibrations during recording, and recording may not be carried out satisfactorily. Thus, even though reproduction can be performed without any problems immediately after recording, there may be a case where reproduction cannot be performed over time. Especially, there is a problem that when file management information cannot be read, a file cannot not be read even though the file itself has no defect.

In this case, use of commercially available utility software may enable saving of the file. However, files to be saved are limited to small files such as still image files in which recording areas are gathered together in one place, and it has been difficult to save files such as moving image files in which recording areas are dispersed in many places.

### SUMMARY OF THE INVENTION

According to the present invention, in a method of recording a file onto an information recording medium having a data area for recording the file and a spare area for a replacement process, file management information for managing a file is recorded, management information indicating a recording area of the file of the file management information is recorded in a data area and a spare area, and the file is reproduced based on the management information recorded in the data area and the management information recorded in the spare area.

Further features of the present invention will become apparent from the following description of exemplary embodiments with reference to the attached drawings.

### BRIEF DESCRIPTION OF THE DRAWINGS

FIG. 1 is a flowchart illustrating a file recording method according to an exemplary embodiment of the present invention.

FIG. 2 is a block diagram illustrating an information recording apparatus according to an exemplary embodiment of the present invention.

FIG. 3 is a diagram illustrating a configuration example of a directory according to the present invention.

FIG. 4 is a diagram illustrating a reference relation of management information to AV1 and AV2 files in FIG. 3.

FIGS. 5A, 5B and 5C are diagrams illustrating a file recording process according to the present invention.

FIGS. 6A, 6B and 6C are diagrams illustrating a file recording process according to the present invention.

FIGS. 7A and 7B are diagrams illustrating a recording process of AV data and PC data according to the present invention.

FIG. 8 is a diagram illustrating an example of a disk format.

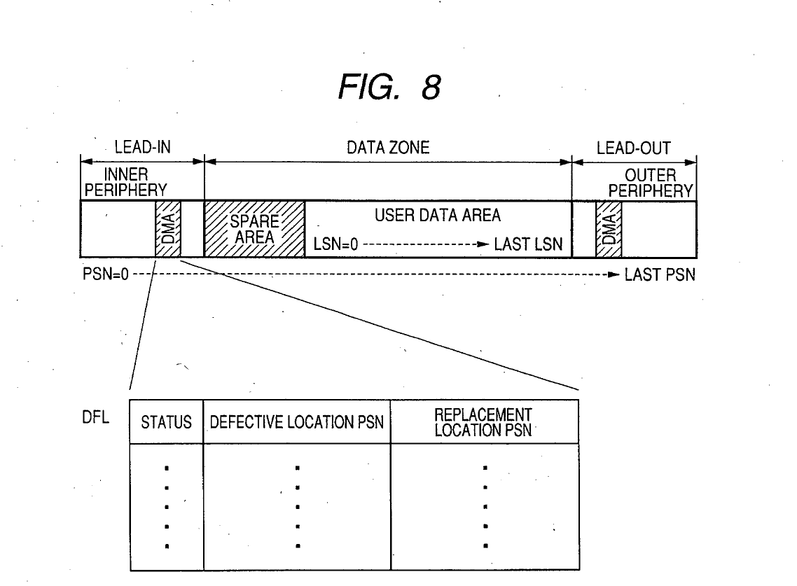

FIG. 9 is a diagram illustrating a replacement process of a conventional example.

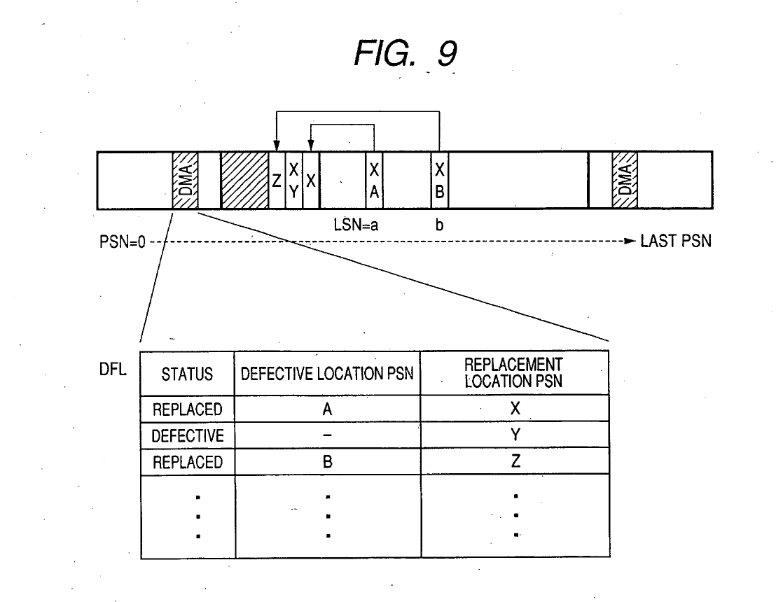

### DESCRIPTION OF THE EMBODIMENTS

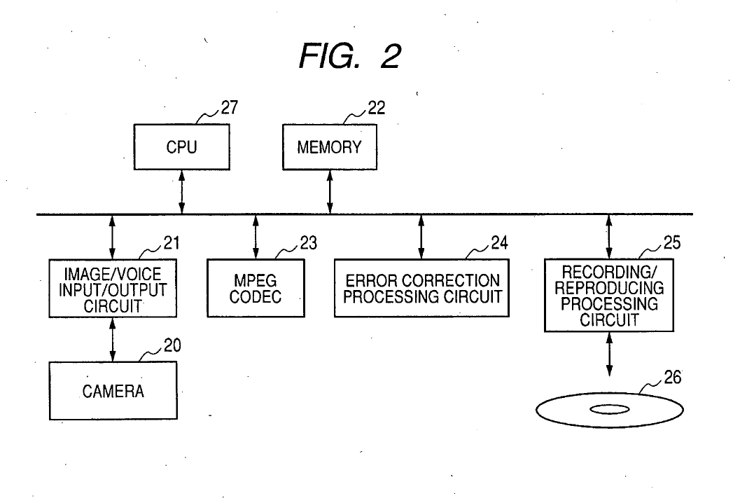

Next, exemplary embodiments of the present invention will be described in detail with reference to the accompanying drawings. FIG. 2 illustrates a configuration of a recording/reproducing apparatus of the present invention.

In the figure, a camera section 20 includes an image input device such as a camera, and a display device such as a display panel. The camera section will be generically referred to as a camera 20 hereinafter. An image/voice input/output circuit 21 performs AD/DA conversion for an image signal (or voice signal). A memory 22 holds image, voice and various management informations. An MPEG CODEC 23 compresses or decompresses the image data or voice data (audio data).

An error correction processing circuit 24 adds an error correction code during recording and corrects errors during reproduction. A recording/reproducing processing circuit 25 modulates or demodulates a signal and records or reproduces information to or from a disk medium 26 which is an information recording medium. The disk medium 26 is an optical disk or the like. A CPU 27 controls the entire apparatus.

First, an image signal input from the camera 20 is digitized by the image/voice input/output circuit 21 and written onto the memory 22. Image data of the memory 22 is read by the MPEG CODEC 23, compressed, encoded, and written again onto the memory 22. The encoded image data is added with an error correction code by the error correction processing circuit 24, modulated by the recording/reproducing processing circuit 25 and recorded on the disk medium 26.

At this time, the image data to be written is recorded as a file. Then, a logical sector number (file location information) of a head of the file and a file size are created as file management information in the memory 22 by the CPU 27, and recorded separately from the image data in the disk medium 26. This file management information will be described later.

When reproducing the recorded image data, the file management information is first read to obtain the location information and size information of the image file. Then, the image data is subjected to signal processing in a path reverse to that during the recording and displayed in the display panel of the camera 20.

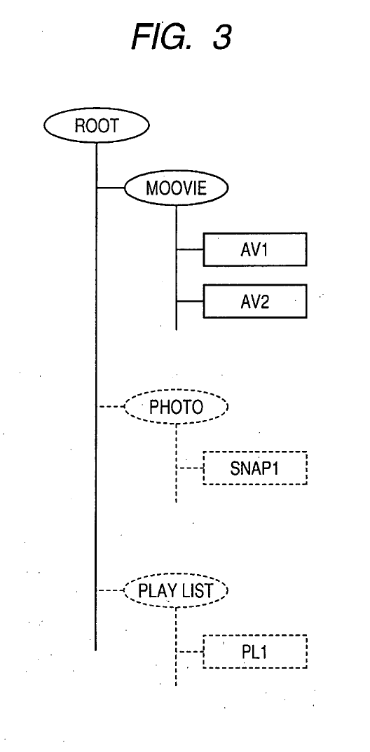

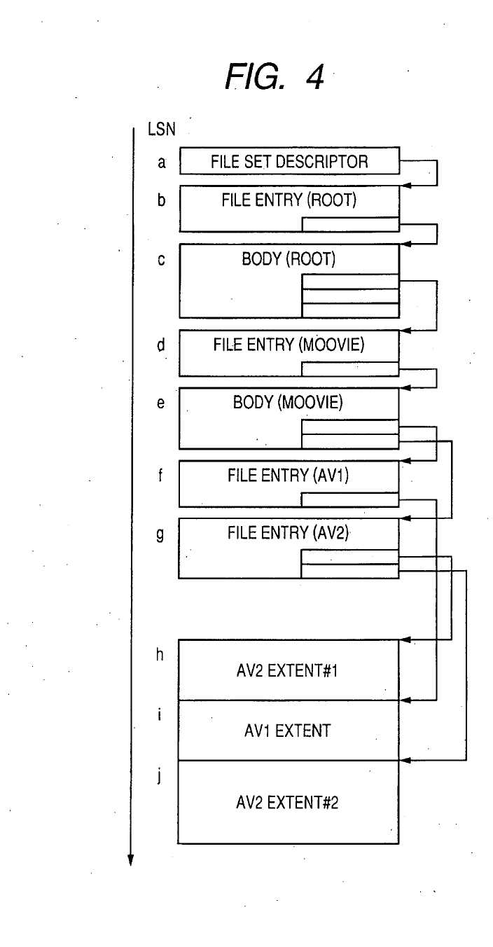

Next, referring to FIGS. 3 and 4, how various files containing image data in the disk medium 26 are managed will be described. FIG. 3 illustrates an example of a directory structure. There are subdirectories such as Movie, Photo, and PlayList subordinate to Root directory, and there are some file groups subordinate to each subdirectory.

For example, AV1 and AV2 in the Movie directory are movie files compressed by an MPEG system, and Snap 1 in the Photo directory is a still (picture) image compressed by a JPEG system. PL1 in the PlayList directory is a type of a scenario which uses the movie or still image files and is a file which describes a reproduction order of the respective files and the like.

FIG. 4 is a diagram specifically illustrating reference information of management informations regarding the AV1 and AV2 files. In the optical disk, a file system standard called Universal Disk Format (UDF) is generally used, and FIG. 4 is compliant with the UDF standard. The a to j in the figure indicate LSNs and references (pointers) indicated by arrows are all performed by using LSNs.

Referring to FIG. 4, a procedure of reproducing an MPEG file, for example the AV1, will be described. First, by a File Set Descriptor a, the information of the entire disk and the location of the Root directory are referred to. The Root directory is composed of a pair of File Entry and Body (b and c), and the Body is referred to by a pointer. Subsequently, a subdirectory Movie (d and e) are referred to, and the file AV1 (f and i) is lastly referred to.

As described above, in the UDF, the File Entry and the Body of the file or the directory are normally recorded in locations apart from each other, and location information and size information of the Body are generally set in the File Entry. File Extent of the location i lastly obtained through sequentially tracking the pointers is an image data body of the MPEG. This image data body can be read and input to an MPEG decoder or the like, thereby reproducing an image.

On the other hand, in the case of the file AV2, Body is divided into two regions of Extent#1 and Extent#2 (h and j) and recorded. The information to the locations and sizes thereof is recorded in File Entry of the location g. In this file system, in order to enable deletion or editing of files, a mechanism is prepared which enables management of a file even when divided into many portions.

When reading of any part is disabled in the path of tracing the pointers from the superordinate directory to the subordinate directory, the file system cannot refer to a target file. However, only for reproducing the image, it is only necessary to know the recording locations and sizes of the Body (Extents of AV1 and AV2) of the MPEG file. It can therefore be seen that the informations written in the File Entries (f and g) thereof are most important.

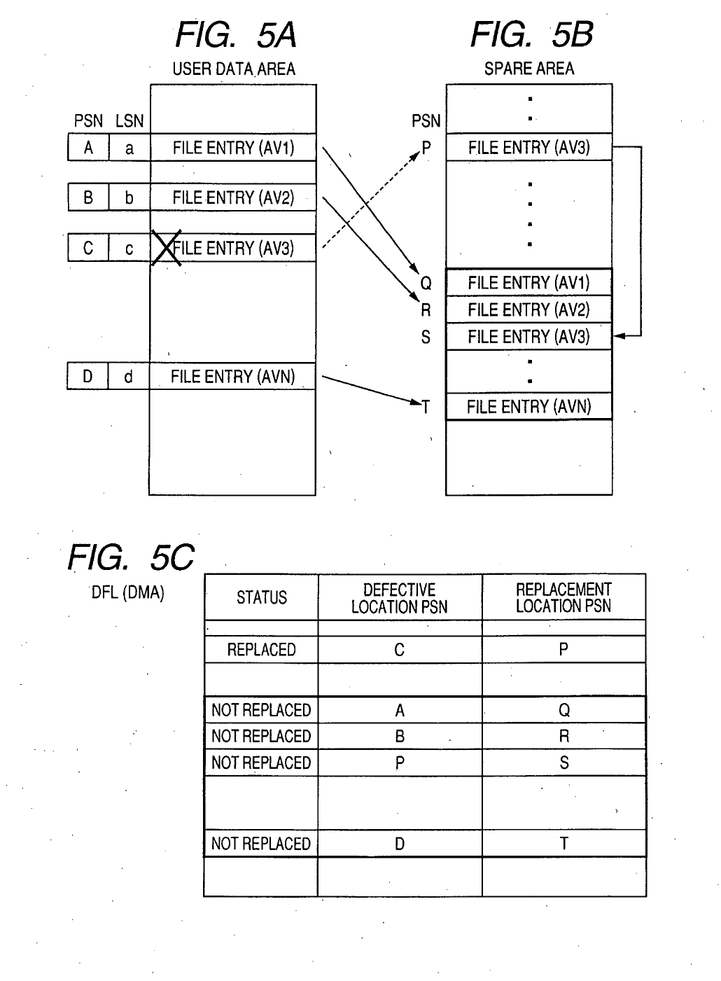

Referring to FIGS. 5A, 5B and 5C, a method of using a spare area to protect the information of the File Entry will be described below. FIG. 5A illustrates information of a user data area, and FIG. 5B illustrates information of a spare area. FIG. 5A illustrates recording locations of respective File Entries on the presumption that there are N MPEG files in the disk medium. Each lowercase alphabet character indicates LSN, and each uppercase alphabet character indicates PSN.

FIG. 5B illustrates contents of the spare area, in which a portion surrounded by a thick frame is an added part for protection. FIG. 5C illustrates contents of DFL, in which a portion surrounded by a thick frame is an added list for protection.

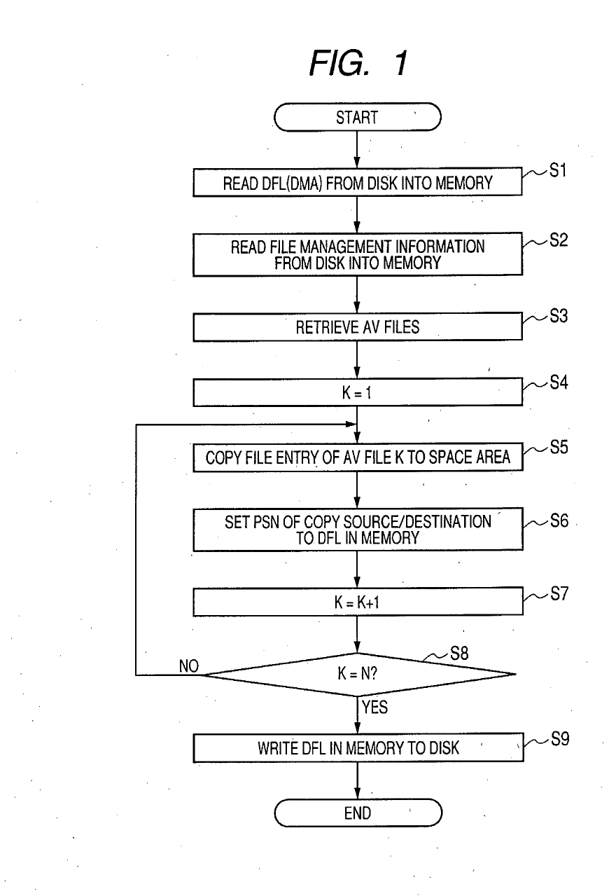

Referring to FIG. 1, a specific procedure of a recording method of file protection according to the present invention will be described. First, in Step S1 of FIG. 1, DFL is read from the disk medium 26 into the memory 22. The DFL at this time does not have the thick frame portion shown in FIG. 5C.

Then, in Step S2, the file management information is read from the disk medium 26 into the memory 22. In FIG. 4, the file management information refers to information regarding the path starting from the File Set Descriptor through the pointers to acquisition of the File Entries of all the files. In Step S3, by retrieving the file management information, it can be seen that there are N image files.

In Step S4, with the number of image files set to K=1, the file “AV1” is selected as a first file. In Step S5, the File Entry of this file is copied to the spare area. Then, in Step S6, the DFL is registered in the memory 22.

Specifically, as illustrated in FIGS. 5A and 5B, the File Entry of the location PSN A is copied to the location Q of the spare area. Further, as illustrated in FIG. 5C, a DFL for replacing the location “A” with “Q” is added. At that time, Status is kept unchanged (or not replaced) because there is actually no defect.

The processing of the first file is thus finished, and then the process proceeds to the processing of a next file with K=K+1 (S7 and S8) and a similar processing is performed repeatedly. Upon completion of the processing of all the image files, as illustrated in FIGS. 5A, 5B and 5C, the File Entries of PSNs “B”, “C”, and “D” are, respectively, copied to PSNs “R”, “S”, and “T” to create a corresponding DFL.

A point to be noted here is the File Entry of the location “C”. Since there was a defect in this location, conventional replacement processing has been performed, so that the File Entry of the LSN “c” is recorded in a location PSN “P”, not in the PSN “C”.

Accordingly, the File Entry of the location “P” is copied to the PSN “S”. The corresponding DFL for replacing “P” with “S” is set. Upon completion of all the processing of N image files, in Step S9, as illustrated in FIG. 5C, the DFL of the memory 22 is written on the disk medium 26 to finish the process.

Incidentally, although the flowchart of FIG. 1 has been described on the assumption that all the image data have been recorded, a File Entry may be backed up in a spare area every time one image is recorded.

Thus, a disk having File Entries of the image files recorded in the spare area different from the original locations is completed. Because Status of the DFL is “Not Replaced”, normal image file reproduction can be performed as usual.

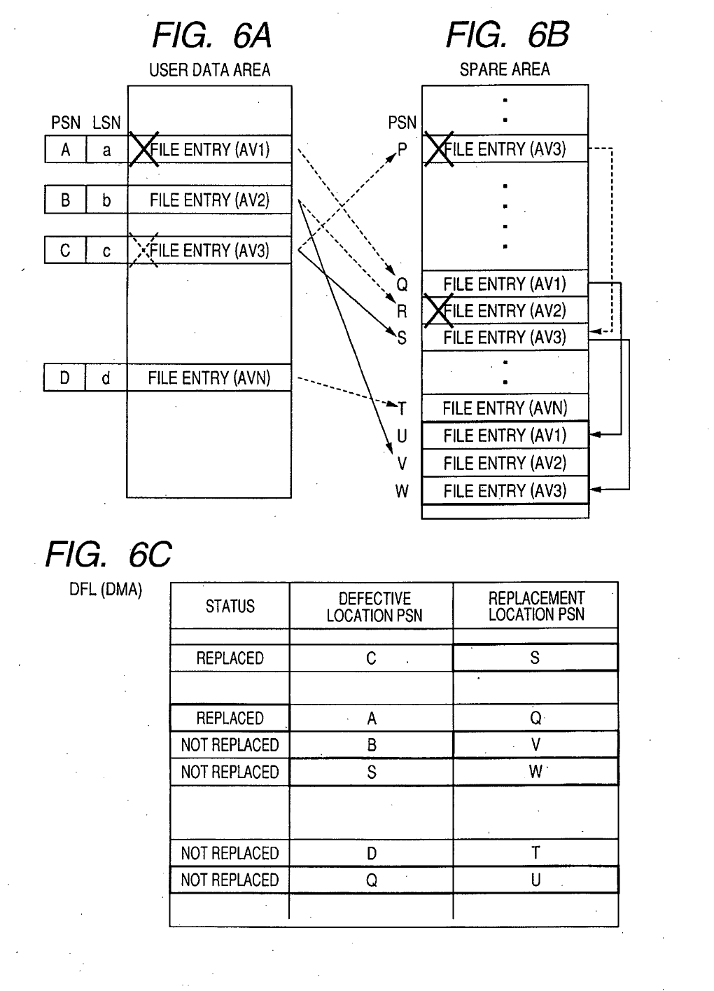

Next, referring to FIGS. 6A, 6B and 6C, an operation in a case where a fault occurs in image file reproduction due to a new flaw or stain will be described.

(1) AV1 File

As illustrated in FIG. 6A, when the File Entry of the PSN “A” cannot be read, because there is a copy in the PSN “Q” as illustrated in FIG. 6B, it is only necessary to change the status of DFL for replacing “A” with “Q”, from “Not Replaced” to “Replaced” as illustrated in FIG. 6C. Accordingly, normal reproduction is enabled by using the DFL of FIG. 6C. However, as the number of File Entry locations is only one, i.e., the location “Q”, “Q” is copied to “U” as illustrated in FIG. 6B, and a DFL is added as illustrated in FIG. 6C. The status for the additional DFL is kept “Not Replaced”.

(2) AV2 File

As illustrated in FIG. 6B, when a defect is caused in a replacement location “R”, there is no problem in image reproduction, and the location “R” is not accessed in a normal reproduction procedure, so that the defect itself is not noticed. However, in order to improve the reliability, it is necessary to access data of the location in which the status of the DFL is not replaced by a user's inspection command or the like. If a defect is found due to the inspection, the File Entry of “B” of FIG. 6A is copied to “V” as illustrated in FIG. 6B, and the DFL is switched from “R” to “V” as illustrated in FIG. 6C.

(3) AV3 File

In a case where a defect is caused in the spare area “P” already replaced as illustrated in FIG. 6B, first, as illustrated in FIG. 6C, the replacement location of “C” is changed from “P” to “S” to enable reproduction. Further, the File Entry of “S” is backed up to “W” as illustrated in FIG. 6B, and a DFL corresponding thereto is added as illustrated in FIG. 6C.

As described above, even when a new defect is caused, because the File Entry, i.e., the location and size of the image data, are held in two locations, the image can be reproduced even if the File Entry held in one of the two locations is lost. Further, by backing up the File Entry which is held in the remaining one location because of the defect, new defects caused afterward can be dealt with.

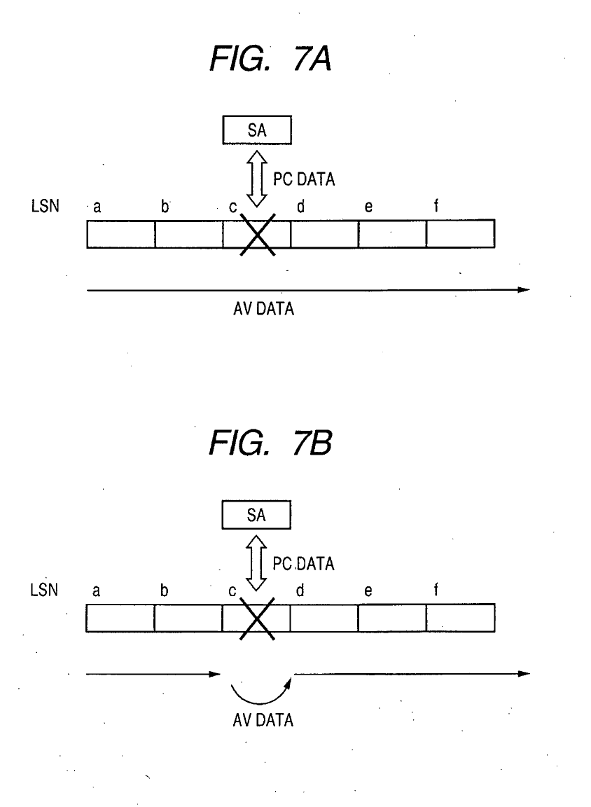

Meanwhile, although a defect of the image data body (Extent) itself has not been described, the image data or voice data (or audio data) is called AV data and distinguished from PC data (file management information or other general files). As a real-time operation takes precedence in recording of AV data, a replacement process is not basically carried out. Further, a verify process (for verifying whether adequate reproduction is performed immediately after recording) is not carried out either. Referring to FIGS. 7A and 7B, this process will be described.

FIG. 7A illustrates an example of a recording process in a case where a defect is present in a certain block which is unknown. In the case of PC data, since writing and verifying are repeated sequentially from the LSN “a” for each block, the block with the defect can be found (c block in this case). Data to be written in the c block is written in the spare area by the replacement process.

In the case of AV data, the defect of the c block cannot be found because no verify process is carried out. Thus, an error remains during reproduction. However, in the case of an image, there is a problem that a still image is generated instantaneously or a part of the image on a screen is disturbed. However, such an error is permitted because of being not fatal.

FIG. 7B illustrates an example of a recording process when a block with a defect is known beforehand. For the PC data, the replacement process is carried out as in the case with the example of FIG. 7A. For the AV data, recording is performed with the c block being skipped. In other words, while tracking of the disk medium is continued as such, without recording in the c block, data to be recorded in the c block is recorded in the d block.

This method enables performing of the process not only in real time but also errorlessly. The c block is in a logically empty state, but the PC data can be later recorded in the spare area by the replacement process.

As described above, in the case of the AV data, considering that the data is not completely protected originally and the error is not fatal, the image body (Extent) is not protected also in the present invention.

To implement the present invention, there is a fear that the spare areas may be short. However, in the case where moving image data is mainly recorded, it is considered that there is enough vacancy of the spare area since the image data occupying most of the disk capacity is not subjected to replacement processing.

According to the present invention, the vacancy of the spare area is efficiently used to protect image files. Especially, in a disk apparatus used for a camcorder, because there are many cases where re-image taking is impossible, the protection of image data is highly effective.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Laid-Open No. 2006-132447, filed May 11, 2006, which is hereby incorporated by reference herein in its entirety.

What is claimed is:

1. A method of recording a file onto an information recording medium having a data area for recording the file and a spare area for a replacement process, the method comprising:
recording file management information for managing a file;
recording, in a data area and a spare area, management information indicating a recording area of the file of the file management information; and
reproducing the file based on the management information recorded in the data area and the management information recorded in the spare area.

2. The method according to claim 1, further comprising, when reproduction of the management information of the data area is disabled, reproducing the file based on the management information of the spare area.

3. The method according to claim 2, further comprising:
creating a list indicating correspondence between the management information recorded in the data area and the management information recorded in the spare area;
when reproduction of the management information of the data area is disabled, recording additional information indicating replacement to a corresponding management information in the list; and
reproducing, by the management information having the additional information in the list, the file based on the management information of the spare area.

4. The method according to claim 3, further comprising:
when the reproduction of the management information of the data area is disabled, recording management information corresponding to another region of the spare area such that the management information in the spare area is recorded in two locations; and
adding an item of the recorded management information to the list.

5. The method according to claim 3, further comprising:
when a defect is caused in the management information of the spare area, recording a corresponding management information of the data area in another region of the spare area; and
changing a replacement destination of the corresponding management information in the list to the management information recorded in the another region.

6. The method according to claim 4, further comprising:
when a defect is caused in the management information recorded in one of the two locations of the spare area, changing a replacement destination of the list to the management information recorded in the other of the two locations;
recording corresponding management information in the other region of the spare area; and
adding an item of the recorded management information to the list.

7. The method according to claim 1, wherein information indicating the recording area of the file comprises a File Entry of a universal disk format.

8. The method according to claim 1, wherein the file comprises a moving image file.

9. The method according to claim 1, wherein the information indicating the recording area of the file comprise a logical sector number of a head of the recording area and a size of the file.

10. An apparatus for recording a file onto an information recording medium having a data area for recording the file and a spare area for a replacement process, the apparatus comprising:
a circuit for recording, in a data area and a spare area, information indicating a recording area of the file of the file management information for managing the file; and
a circuit for reproducing the file based on the management information recorded in the data area and the management information recorded in the spare area.
